(19) United States
(12) Patent Application Publication
(10) Pub. No.: US 2012/0051176 A1
(43) Pub. Date: Mar. 1, 2012

(54) REVERSE TIME MIGRATION BACK-SCATTERING NOISE REMOVAL USING DECOMPOSED WAVEFIELD DIRECTIVITY

(75) Inventor: Wei Liu, San Ramon, CA (US)

(73) Assignee: Chevron U.S.A. Inc.

(21) Appl. No.: 12/872,927

(22) Filed: Aug. 31, 2010

(51) Int. Cl. G01V 1/28

(52) U.S. Cl. 367/38

(57) ABSTRACT

Images of a subsurface region may be generated in conjunction with reverse time migration with reduced or no backscattering noise. Two or more wavefields may be decomposed to produce two or more corresponding decomposed wavefields. The two or more decomposed wavefields may include a source wavefield and a receiver wavefield. Directivity of the two or more decomposed wavefields may be determined to produce corresponding direction-dependent components of the two or more decomposed wavefields. One or more of the direction-dependent components of one or more decomposed source wavefields may be cross-correlated with one or more of the direction-dependent components of one or more corresponding decomposed receiver wavefields. An image of the subsurface region may be generated based on the cross-correlation.

### FIELD OF THE DISCLOSURE

The disclosure relates to removing back-scattering noise in reverse time migration using decomposed wavefield directivity for generating images of a subsurface region.

### BACKGROUND OF THE DISCLOSURE

Images of a subsurface region of Earth can be generated using seismic waves. Seismic waves from one or more wave sources (i.e., source wavefields) at or near Earth's surface propagate through an adjacent subsurface region and are reflected or scattered by interfaces between geological features (e.g., layers having different compositions and/or propagation properties) back to the surface. The reflected or scattered waves are received by one or more wave receivers (i.e., receiver wavefields). The source and receiver waves can then be used to generate images of the subsurface region. This kind of source and receiver correlation imaging condition can be applied to various acquisition geometries, such as, surface source-receiver geometries, vertical seismic profile (VSP) geometries, ocean bottom node/cable (OBN/OBC) geometries, and/or other geometries.

Reverse time migration is a powerful method that utilizes waves propagating in one or more directions (e.g., source waves, reflected and/or scattered receiver waves, and/or other seismic waves) for imaging. Generally, reverse time migration can be performed by computationally propagating wave equations forward in time for source wave and backwards in time for receiver waves. Application of conventional imaging conditions in reverse time migration upon head waves or turning waves can result in undesired backscattering noise (e.g., low-wave-number artifacts) at some image locations such as above strong impedance contracts. This backscattering noise may lead to blurred portions of an image of a subsurface region. Backscattering noise may arise from cross-correlation of source wavefields and receiver wavefield reflections propagating in opposite directions. FIG. 1 illustrates characteristics of backscattering noise in shallow sediments in an image 100 of a subsurface region. Such backscattering noise tends to smear structural images and make interpretation above strong reflectors difficult.

In the past, several approaches have been proposed to mitigate backscattering noise in shallow sediments. These approaches can be categorized into two groups: modifying imaging conditions and image filtering. Conventional approaches that involve modifying imaging conditions have major limitations for practical use due, for example, to over-restrictiveness, computation costliness, and/or vulnerability to the presence of crossing events. Conventional approaches that involve image filtering compromise true amplitude processing and, furthermore, the degree of effectiveness of these approaches is dependent on structural complexity, model specifics, and acquisition settings.

### SUMMARY

One aspect of the disclosure relates to a computer-implemented method for generating images of a subsurface region. The method may include decomposing two or more wavefields to produce two or more corresponding decomposed wavefields. The two or more wavefields may include a source wavefield and a receiver wavefield. The method may include determining directivity of the two or more decomposed wavefields to produce corresponding direction-dependent components of the two or more decomposed wavefields. The method may include cross-correlating one or more of the direction-dependent components of one or more decomposed source wavefields with one or more of the direction-dependent components of one or more decomposed receiver wavefields. The method may include generating an image of the subsurface region based on the cross-correlation.

Another aspect of the disclosure relates to a system configured to generate images of a subsurface region. The system may include one or more processors configured to execute computer program modules. The computer program modules may include a wavefield decomposition module, a wavefield directivity determination module, a cross-correlation module, an image generation module, and/or other modules. The wavefield decomposition module may be configured to decompose two or more wavefields to produce two or more corresponding decomposed wavefields. The two or more wavefields may include a source wavefield or a receiver wavefield. The wavefield directivity determination module may be configured to determine directivity of the two or more decomposed wavefields to produce corresponding direction-dependent components of the two or more decomposed wavefields. The cross-correlation module may be configured to cross-correlate one or more of the direction-dependent components of one or more decomposed source wavefields with one or more of the direction-dependent components of one or more decomposed receiver wavefields. The image generation module configured to generate an image of the subsurface region based on the cross-correlation performed by the cross-correlation module.

Yet another aspect of the disclosure relates to a computer-readable storage medium having instructions embodied thereon. The instructions may be executable by a processor to perform a method for generating images of a subsurface region. The method may include decomposing two or more wavefields to produce two or more corresponding decomposed wavefields. The two or more wavefields may include a source wavefield and a receiver wavefield. The method may include determining directivity of the two or more decomposed wavefields to produce corresponding direction-dependent components of the two or more decomposed wavefields. The method may include cross-correlating one or more of the direction-dependent components of one or more decomposed source wavefields with one or more of the direction-dependent components of one or more decomposed receiver wavefields. The method may include generating an image of the subsurface region based on the cross-correlation.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the technology. As used in the specification and in the claims, the singular form of “a”, “an”, and “the” include plural referents unless the context clearly dictates otherwise.

### BRIEF DESCRIPTION OF THE DRAWINGS

FIG. 1 illustrates characteristics of backscattering noise in shallow sediments in an image of a subsurface region.

FIG. 2 illustrates a system configured to generate images of a subsurface region, in accordance with one or more embodiments of the present technology.

FIG. 3a illustrates an image of a subsurface region where backscattering noise removal was attempted using conventional image filtering approaches.

FIG. 3b illustrates an image of the same subsurface region as in FIG. 3a where backscattering noise was removed using one or more embodiments of the present technology.

FIG. 4 illustrates a method for generating images of a subsurface region, in accordance with one or more embodiments of the present technology.

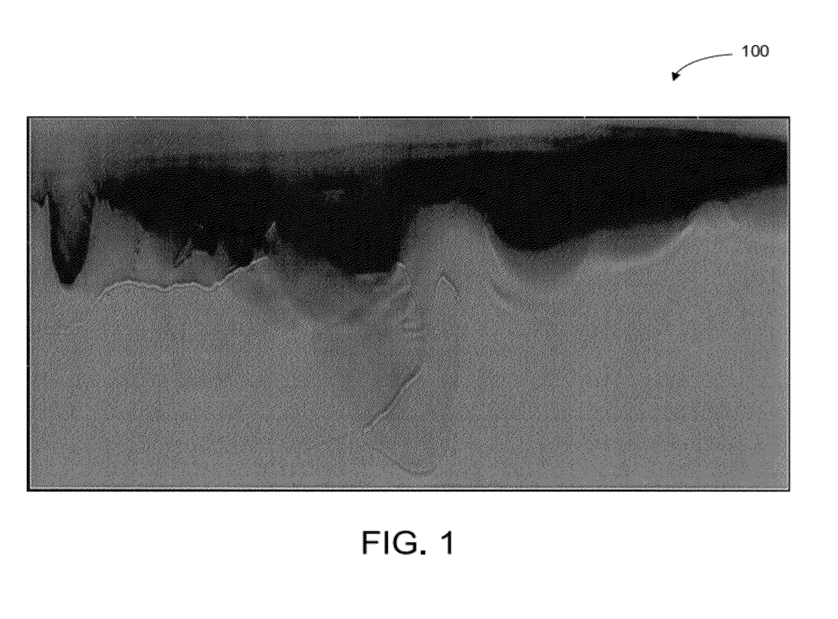

### DETAILED DESCRIPTION

The present technology may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present technology may be coded in different languages for application in a variety of computing platforms and environments. It will be appreciated that the scope and underlying principles of the present technology are not limited to any particular computer software technology.

Moreover, those skilled in the art will appreciate that the present technology may be practiced using any one or combination of hardware and software configurations, including but not limited to a system having single and/or multi-processor computer processors system, hand-held devices, programmable consumer electronics, mini-computers, mainframe computers, and the like. The technology may also be practiced in distributed computing environments where tasks are performed by servers or other processing devices that are linked through one or more data communications networks. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present technology. Such devices and articles of manufacture also fall within the spirit and scope of the present technology.

Referring now to the drawings, embodiments of the present technology will be described. The technology can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present technology are discussed below. The appended drawings illustrate only typical embodiments of the present technology and therefore are not to be considered limiting of its scope and breadth.

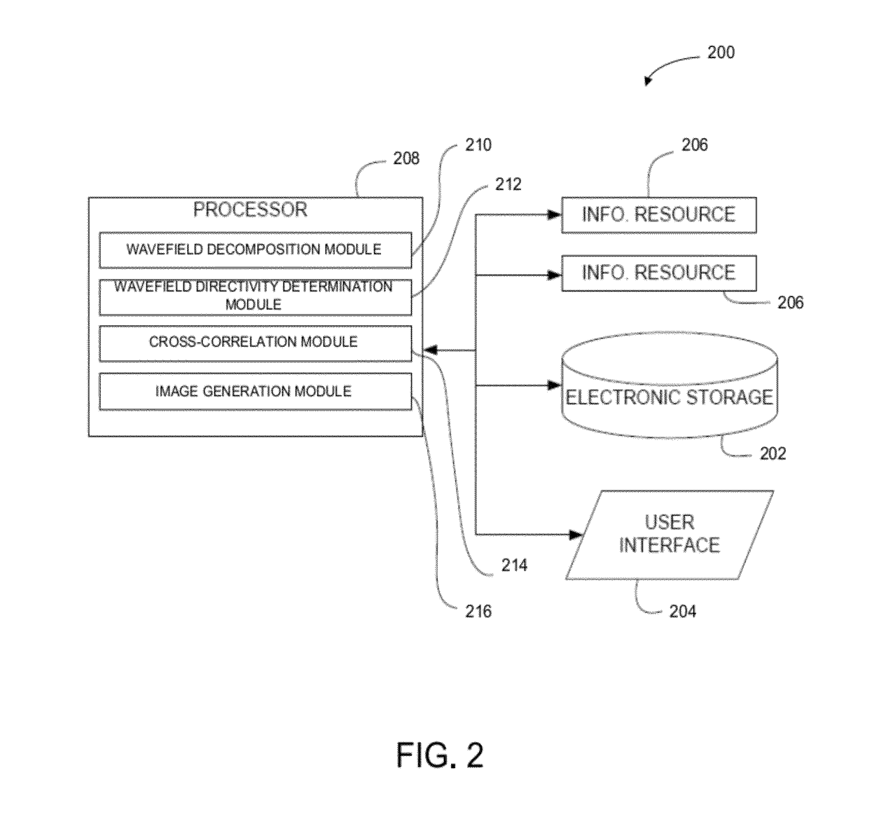

FIG. 2 illustrates a system 200 configured to generate images of a subsurface region, in accordance with one or more embodiments of the present technology. In exemplary embodiments, wavefield directivity of decomposed wavefields may be determined by applying a wavefield separation to at least one of a source wavefield or a receiver wavefield. Wavefield decomposition or separation may be performed using a numerical transformation, which may reduce matrix transpose and memory buffering. The directivity of a wavefield may be estimated using several wavefields related in time. Directivity-based wavefield components can be used to as an imaging condition to completely discard or reduce undesired backscattering noise. In one embodiment, system 200 includes electronic storage 202, a user interface 204, one or more information resources 206, one or more processors 208, and/or other components.

In one embodiment, electronic storage 202 includes electronic storage media that electronically stores information. The electronic storage media of electronic storage 202 may include system storage that is provided integrally (i.e., substantially non-removable) with system 200 and/or removable storage that is removably connectable to system 200 via, for example, a port (e.g., a USB port, a firewire port, etc.) or a drive (e.g., a disk drive, etc.). Electronic storage 202 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 202 may store software algorithms, information determined by processor 208, information received via user interface 204, information received from information resources 206, and/or other information that enables system 200 to function properly. Electronic storage 202 may be a separate component within system 200, or electronic storage 202 may be provided integrally with one or more other components of system 200 (e.g., processor 208).

User interface 204 is configured to provide an interface between system 200 and a user through which the user may provide information to and receive information from system 200. This enables data, results, and/or instructions and any other communicable items, collectively referred to as “information,” to be communicated between the user and the system 200. As used herein, the term “user” may refer to a single individual or a group of individuals who may be working in coordination. Examples of interface devices suitable for inclusion in user interface 204 include a keypad, buttons, switches, a keyboard, knobs, levers, a display screen, a touch screen, speakers, a microphone, an indicator light, an audible alarm, and a printer. In one embodiment, user interface 204 actually includes a plurality of separate interfaces.

It is to be understood that other communication techniques, either hard-wired or wireless, are also contemplated by the present disclosure as user interface 204. For example, the present disclosure contemplates that user interface 204 may be integrated with a removable storage interface provided by electronic storage 202. In this example, information may be loaded into system 200 from removable storage (e.g., a smart card, a flash drive, a removable disk, etc.) that enables the user(s) to customize the implementation of system 200. Other exemplary input devices and techniques adapted for use with system 200 as user interface 204 include, but are not limited to, an RS-232 port, RF link, an IR link, modem (telephone, cable or other). In short, any technique for communicating information with system 200 is contemplated by the present disclosure as user interface 204.

The information resources 206 include one or more sources of information related to a subsurface region and/or the process of generating images of a subsurface region. By way of non-limiting example, one of information resources 206 may include seismic data acquired at or near the geological volume of interest, information derived therefrom, and/or information related to the acquisition. The seismic data may include individual traces of seismic data, or the data recorded at on one channel of seismic energy propagating through the subsurface region from a source. The information derived from the seismic data may include, for example, a velocity model, beam properties associated with beams used to model the propagation of seismic energy through the subsurface region, Green's functions associated with beams used to model the propagation of seismic energy through the subsurface region, and/or other information. Information related to the acquisition of seismic data may include, for example, data related to the position and/or orientation of a source of seismic energy (e.g., source wavefields), the positions and/or orientations of one or more detectors or receivers of seismic energy (e.g., receiver wavefields), the time at which energy was generated by the source and directed into the subsurface region, and/or other information.

Processor 208 is configured to provide information processing capabilities in system 200. As such, processor 208 may include one or more of a digital processor, an analog processor, a digital circuit designed to process information, an analog circuit designed to process information, a state machine, and/or other mechanisms for electronically processing information. Although processor 208 is shown in FIG. 2 as a single entity, this is for illustrative purposes only. In some implementations, processor 208 may include a plurality of processing units. These processing units may be physically located within the same device or computing platform, or processor 208 may represent processing functionality of a plurality of devices operating in coordination.

As is shown in FIG. 2, processor 208 may be configured to execute one or more computer program modules. The one or more computer program modules may include one or more of a wavefield decomposition module 210, a wavefield directivity determination module 212, a cross-correlation module 214, an image generation module 216, and/or other modules. Processor 208 may be configured to execute modules 210, 212, 214, and/or 216 by software; hardware; firmware; some combination of software, hardware, and/or firmware; and/or other mechanisms for configuring processing capabilities on processor 208.

It should be appreciated that although modules 210, 212, 214, and 216 are illustrated in FIG. 2 as being co-located within a single processing unit, in implementations in which processor 208 includes multiple processing units, one or more of modules 210, 212, 214, and/or 216 may be located remotely from the other modules. The description of the functionality provided by the different modules 210, 212, 214, and/or 216 described below is for illustrative purposes, and is not intended to be limiting, as any of modules 210, 212, 214, and/or 216 may provide more or less functionality than is described. For example, one or more of modules 210, 212, 214, and/or 216 may be eliminated, and some or all of its functionality may be provided by other ones of modules 210, 212, 214, and/or 216. As another example, processor 208 may be configured to execute one or more additional modules that may perform some or all of the functionality attributed below to one of modules 210, 212, 214, and/or 216.

The wavefield decomposition module 210 may be configured to decompose one or more wavefields to produce one or more corresponding decomposed wavefields. In some embodiments, the wavefields may include one or both of a source wavefield or a receiver wavefield. In such embodiments, the one or more decomposed wavefields may include wavefields associated with the source wavefield and/or the receiver wavefield. The wavefield decomposition module 210 may be further configured to decompose the one or more wavefields, at least in part, by performing a numerical transformation on the one or more wavefields. Examples of such a numerical transformation may include a fast-Fourier transformation, windowed fast-Fourier transformation, and/or other numerical transformations.

As mentioned above, a windowed fast-Fourier transformation may be performed by the wavefield decomposition module 210 to decompose one or more wavefields to produce one or more corresponding decomposed wavefields, in accordance with some embodiments. Windowed fast-Fourier transformation may be performed on wavefields in a portion of the subsurface region (i.e., subsurface sub-region), which may reduce computational costs. This may be performed on a single portion of the subsurface region at a time, or on a plurality of portions of the subsurface region simultaneously, in accordance with various embodiments. To decompose wavefields across the entire subsurface region, two or more subsurface sub-regions may be defined to have overlapping boundary points, which may relieve memory constraints. Amplitude tapering may be used at or near the boundary points to reduce artifacts of truncation. In some embodiments, the transformation may be done without windowing, but in a cache-friendly way to achieve high performance. Windowing of wavefields in the subsurface region may be performed in the time domain and the space domain (i.e., space-time domain). Wavefields in the subsurface sub-regions may be transformed to the frequency domain. Wave number based and/or frequency based calculations may be performed on the transformed wavefields of the subsurface sub-regions, for example, to discriminate waves propagating up/down, left/right, back/forth, and/or in otherwise opposite directions. The wavefields may then be transformed back to the space-time domain as decomposed wavefields.

The wavefield directivity determination module 212 may be configured to determine directivity of the one or more decomposed wavefields to produce corresponding direction-dependent components of the one or more decomposed wavefields. Directivity may include information indicating a direction in which a wavefield is propagating (e.g., up, down, left, right, diagonally, and/or other direction). Directivity may be measured by using a plurality of wavefields related in time Based on directivity, individual direction-dependent components may be selected out as a conditioning upon decomposed wavefields. According to some embodiments, source wavefields propagating forward in time and receiver wavefields propagating backward in time may be selected. The selected source wavefields and the selected receiver wavefields may be physically propagating in arbitrary directions within the subsurface region. By using decomposed wavefields, directivity can be determined more accurately and robustly, relative to conventional approaches. The wavefield directivity determination module 212 may be further configured to utilize a plurality of time-states of individual ones of the one or more decomposed wavefields to determine directivity of the one or more decomposed wavefields.

The cross-correlation module 214 may be configured to cross-correlate two or more of the direction-dependent components of the one or more decomposed wavefields. In exemplary embodiments, the cross-correlated two or more of the direction-dependent components may include a source wavefield and a receiver wavefield. The cross-correlated two or more of the direction-dependent components may include a source wavefield propagating forward in time and a receiver wavefield propagating backward in time. The cross-correlated two or more of the direction-dependent components may include wavefields physically propagating in arbitrary directions within the subsurface region.

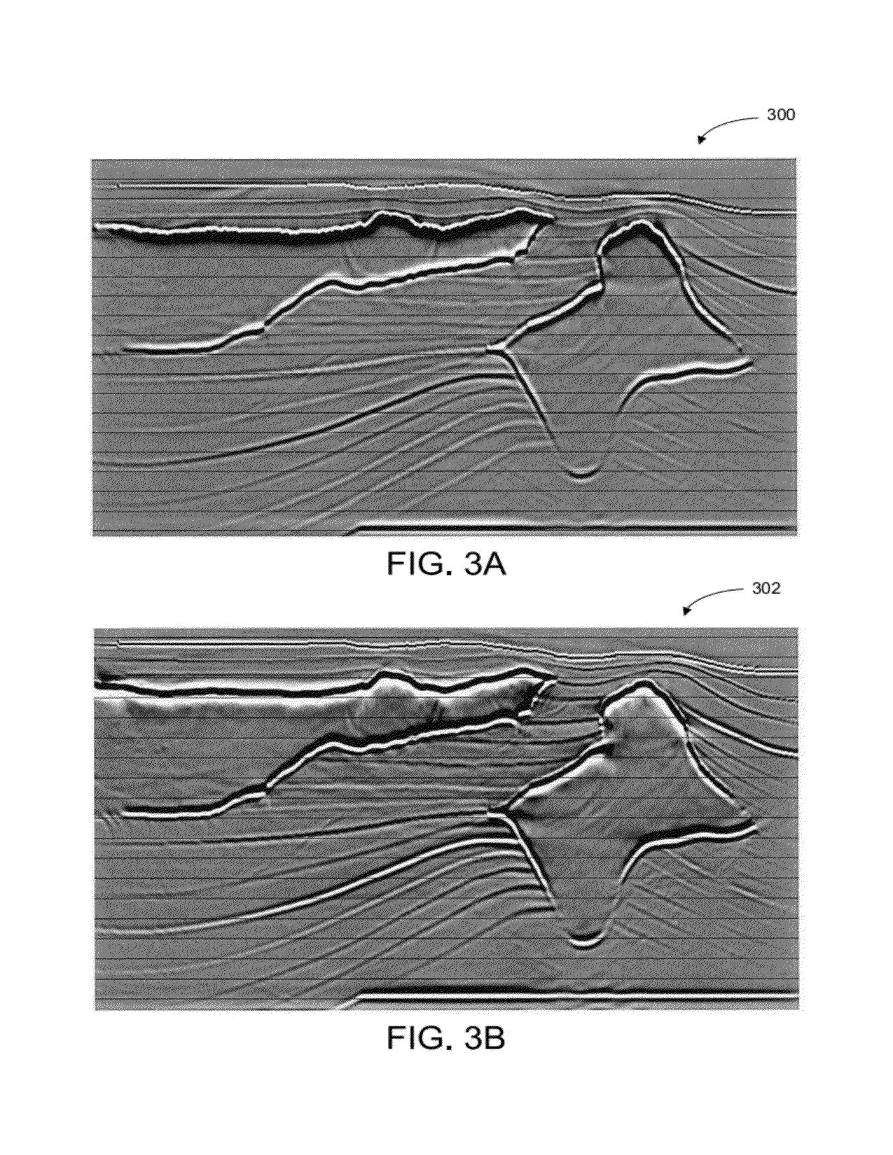

The image generation module 216 may be configured to generate an image of the subsurface region based on the cross-correlation performed by the cross-correlation module 214. In exemplary embodiments, the image is generated so as to be devoid of backscattering noise by using cross-correlated, direction-dependent components of a source wavefield and a receiver wavefield. Relative to images generated using conventional approaches, an image of the subsurface region generated by way of exemplary embodiments may have less noise due to backscattering in one or more portions of the image and can preserve phase and amplitude fidelity of the images more accurately. For example, FIG. 3a illustrates an image 300 of a subsurface region where backscattering noise removal was attempted using conventional image filtering approaches. FIG. 3b illustrates an image 302 of the same subsurface region as in FIG. 3a where backscattering noise was removed using one or more embodiments of the present technology. It is noteworthy that sediment layers have less smearing noise or noise residual from filtering and their amplitude fidelity are improved in the image 302, relative to the image 300.

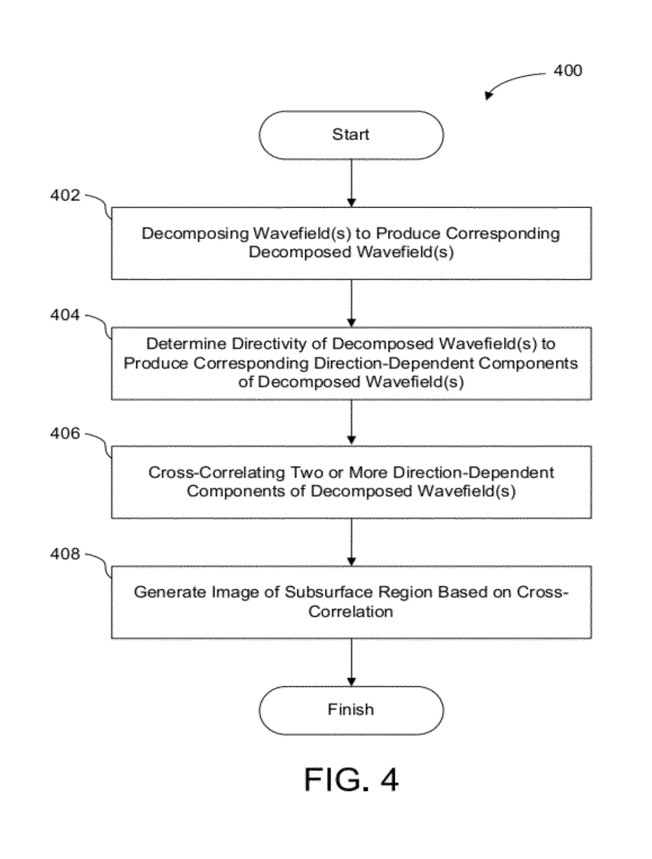

FIG. 4 illustrates a method 400 for generating images of a subsurface region, in accordance with one or more embodiments of the present technology. The operations of the method 400 presented below are intended to be illustrative. In some embodiments, the method 400 may be accomplished with one or more additional operations not described, and/or without one or more of the operations discussed. Additionally, the order in which the operations of the method 400 are illustrated in FIG. 4 and described below is not intended to be limiting.

In some embodiments, the method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 400 in response to instructions stored electronically on an electronic storage medium. The one or more processing devices may include one or more devices configured through hardware, firmware, and/or software to be specifically designed for execution of one or more of the operations of the method 400.

At an operation 402, one or more wavefields are decomposed to produce one or more corresponding decomposed wavefields. The one or more wavefields may include one or both of a source wavefield and a receiver wavefield. According to some embodiments, the wavefield decomposition module 210 may be executed to perform the operation 402.

At an operation 404, directivity of the one or more decomposed wavefields is determined to produce corresponding direction-dependent components of the one or more decomposed wavefields. The wavefield directivity determination module 212 may be executed to perform the operation 404, in accordance with some embodiments.

At an operation 406, two or more of the direction-dependent components of the one or more decomposed wavefields may be cross-correlated. The operation 406 may be performed by way of execution of the cross-correlation module 214 in some embodiments.

At an operation 408, an image of the subsurface region is generated based on the cross-correlation performed in the operation 406. As such, the image of the subsurface region may be devoid of backscattering noise. In some embodiments, the image generation module 216 may be executed to perform the operation 408.

Although the present technology has been described in detail for the purpose of illustration based on what is currently considered to be practical embodiments, it is to be understood that such detail is solely for that purpose and that the technology is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for generating images of a subsurface region, the method comprising:
decomposing two or more wavefields to produce two or more corresponding decomposed wavefields, wherein the two or more wavefields include a source wavefield and a receiver wavefield;
determining directivity of the two or more decomposed wavefields to produce corresponding direction-dependent components of the two or more decomposed wavefields;
cross-correlating one or more of the direction-dependent components of one or more decomposed source wavefields with one or more of the direction-dependent components of one or more decomposed receiver wavefields; and
generating an image of the subsurface region based on the cross-correlation.

2. The method of claim 1, wherein decomposing the two or more wavefields includes performing a numerical transformation on the one or more wavefields.

3. The method of claim 2, wherein the numerical transformation is a fast Fourier transformation.

4. The method of claim 1, wherein a plurality of time-states of individual ones of the two or more decomposed wavefields are utilized in determining directivity of the two or more decomposed wavefields.

5. The method of claim 1, wherein generated image is devoid backscattering noise.

6. A system configured to generate images of a subsurface region, the system comprising:
one or more processors configured to execute computer program modules, the computer program modules comprising:
a wavefield decomposition module configured to decompose two or more wavefields to produce two or more corresponding decomposed wavefields, wherein the two or more wavefields include a source wavefield or a receiver wavefield;
a wavefield directivity determination module configured to determine directivity of the two or more decomposed wavefields to produce corresponding direction-dependent components of the two or more decomposed wavefields;
a cross-correlation module configured to cross-correlate one or more of the direction-dependent components of one or more decomposed source wavefields with one or more of the direction-dependent components of one or more decomposed receiver wavefields; and
an image generation module configured to generate an image of the subsurface region based on the cross-correlation performed by the cross-correlation module.

7. The system of claim 6, wherein the wavefield decomposition module is further configured to decompose the two or more wavefields, at least in part, by performing a numerical transformation on the two or more wavefields.

8. The system of claim 7, wherein the numerical transformation is a fast-Fourier transformation.

9. The system of claim 6, wherein the wavefield directivity determination module is further configured to utilize a plurality of time-states of individual ones of the two or more decomposed wavefields to determine directivity of the two or more decomposed wavefields.

10. The system of claim 6, wherein the generated image is devoid backscattering noise.

11. A computer-readable storage medium having instructions embodied thereon, the instructions being executable by a processor to perform a method for generating images of a subsurface region, the method comprising:
decomposing two or more wavefields to produce two or more corresponding decomposed wavefields, wherein the two or more wavefields include a source wavefield and a receiver wavefield;
determining directivity of the two or more decomposed wavefields to produce corresponding direction-dependent components of the two or more decomposed wavefields;
cross-correlating one or more of the direction-dependent components of one or more decomposed source wavefields with one or more of the direction-dependent components of one or more decomposed receiver wavefields; and
generating an image of the subsurface region based on the cross-correlation.

12. The computer-readable storage medium of claim 11, wherein decomposing the two or more wavefields includes performing a numerical transformation on the one or more wavefields.

13. The computer-readable storage medium of claim 12, wherein the numerical transformation is a fast Fourier transformation.

14. The computer-readable storage medium of claim 11, wherein a plurality of time-states of individual ones of the two or more decomposed wavefields are utilized in determining directivity of the two or more decomposed wavefields.

15. The computer-readable storage medium of claim 11, wherein generated image is devoid backscattering noise.
